(19) United States
(12) Patent Application Publication
(10) Pub. No.: US 2016/0363257 A1
(43) Pub. Date: Dec. 15, 2016

(54) Support Device with Transformable Legs

(71) Applicant: John Kirby Kendall, Cedar Park, TX (US)

(72) Inventor: John Kirby Kendall, Cedar Park, TX (US)

(21) Appl. No.: 15/173,308

(22) Filed: Jun. 3, 2016

Related U.S. Application Data
(60) Provisional application No. 62/200,097, filed on Aug. 2, 2015.
(60) Provisional application No. 62/175,320, filed on Jun. 14, 2015.

(51) Int. Cl. F16M 11/40; F16M 11/24; F16M 11/04

(52) U.S. Cl. CPC F16M 11/40; F16M 11/04; F16M 11/041; F16M 11/245

(57) ABSTRACT

The present invention is directed to a support device that holds an item on a stage that is elevated on extended legs in an elongated curved form. To store or transport the support device, the legs are wound around a mandrel into a coil form that is very compact. The supporting leg has a subtending angle ranging from a slit tube with an open gap, to a slit tube where the two edges overlap. The most common form of the invention is a tripod.

### CROSS-REFERENCE TO RELATED APPLICATION

This application claims the benefit of U.S. Provisional Application No. 62/175,320 filed Jun. 14, 2015; and U.S. Provisional Application No. 62/200,097 filed Aug. 2, 2015.

### FIELD OF THE INVENTION

The invention generally relates to a support device with a stage supported by legs that are transformable between an extended slit curve form and a flattened coil form, where the legs are wound around a mandrel.

### BACKGROUND

Support devices that have legs that transform between a compact shape and an in-use, supporting shape are numerous: tables, tripods, monopods, sawhorses, and ironing boards. These support devices generally rest on the floor or ground, and articles are supported by being attached to or simply resting on the support device. Support devices must be robust enough to withstand downward force from its own weight and the weight of the supported article, in addition to lateral and twisting forces from the user and the environment (e.g. wind).

There is a need for support devices that can become more compact than currently-known devices can become. For example, most consumer camera tripods stand about 48 inches above the floor, and in a compact state the legs only compact down to 9-18 inches in length. Thus, the compacted tripod is still relatively bulky and remains too large for small bags and satchels. In this specific example, the problem to be solved is the development of a full-sized tripod that can become compact enough to fit inside of a small bag or a pocket.

Since the greatest contributor to the size of most support devices is the leg, it has been the focus of much transformation development. As such, inventors have created a variety of legs that transform between extended and compact forms by different means. These means include legs that fold (Howe U.S. Pat. No. 2,094,123 and Dickerson 729,291), legs that telescope (Corbett U.S. Pat. No. 1,370,732 and Harris U.S. Pat. No. 2,333,784), and legs that coil (Zerk U.S. Pat. No. 1,962,547). These and other listed literature are incorporated by reference in their entirety. When these references define a word in a way that is inconsistent or contrary to the definition herein, the definition herein applies.

A leg that folds or telescopes is limited in how compact it can become. For example, the Dickerson leg folds in thirds and can only become as compact as one third of its extended length. Legs with additional folds can yield shorter leg segments, but then the numerous segments must be re-linked—adding to complexity, cost, and/or bulk to the support device.

A leg that telescopes is similarly limited in the number of sections that are practical. The Harris leg has two telescoping sections can only become as compact as one half of its extended length. As more sections are added, securing each section in place similarly increases the complexity, cost, and or bulk of the support device.

A leg that transforms from an extended, curved strip; through a transition form; and into a flattened coil does not have discrete segments. However in the past is has been limited in how compact it can become. An example is the Zerk leg which is comprised of a thin resilient metal strip that possesses a curve similar to a retractable tape measure. Zerk states that “it is important to have means to reinforce the strip throughout the length of that [transition form]”. Thus, the most compact state that the leg can achieve is the radius of the coil plus the length of the transition form. Complicating this leg design is that a stronger leg is possible if the strip is widened, but widening the strip increases the length of the transition form—making the support device less compact. Due to the complications of this leg design, this inventor knows of no viable support devices, past or present, that are based on the broad concept of a coil-able leg.

In sum, there exists a need for a practical support device with a coil-able leg that can achieve a compact state that has not yet been demonstrated.

### SUMMARY OF INVENTION

The present invention is directed to methods and an apparatus for a support device that holds an item on a stage that is elevated on extended legs in an elongated curved form (claim 1). To store or transport the support device, the legs are wound around a mandrel into a coil form that is very compact (claim 2). A most preferred number of legs is 3 for a tripod support device (claim 3). The most compact form is when the bottom end of the legs can wind up next to the coil (claim 4), and even any preferred footing does not hinder the fact that the bottom of the leg must become close to the coil to achieve a compact state (claim 6). Also preferred is a handle (claim 9) for the mandrel to ease winding the leg for storage, and a system to secure an item on the stage (claim 12). The legs may be designed so that the height of the support device can be short or tall (claim 10).

Contemplating the leg specifically, it can have a subtending angle ranging from a slit tube with an open gap running its length to a slit tube when the two edges overlap (claim 5). The leg can be made of materials that are termed “bi-stable”, that is, they are stable both as an elongated tube and as the wound-up coil; or the leg can be stable only as the tube (claim 11). The legs may be a pure plastic or a plastic composition (claim 7), with the preferred plastic being polycarbonate or another common plastic (claim 8).

For additional stability of legs it is optional that the legs are supported by a leg guide (claim 13) since it can hold the legs in a support position, yet can also allow the legs to coil as small as possible. Also preferred is attaching the leg to the mandrel with a pin (claim 14) such that the leg can pivot at the pin in order to spread the legs. And a most preferred from of the invention is as a tripod (claim 15).

Various objects, features, aspects, and advantages of the present invention will become more apparent from the following detailed description of preferred embodiments of the invention, along with the accompanying drawing in which like numerals represent like components.

### BRIEF DESCRIPTION OF THE DRAWING

FIG. 1 is a concave view of the partially extended prior art Zerk leg.

FIG. 2 is a concave view of the coiled (fully compacted) prior art Zerk leg.

FIG. 3 is a chart showing that as the subtending angle of a curved leg (variable leg diameter, constant arc length) increases, the mass supported by the leg increases.

FIG. 4 is chart showing that as the subtending angle of a curved leg (variable arc length, constant leg diameter) increases, the mass supported by the leg increases.

FIG. 5 is a concave view illustrating how a single, partially extended leg has the leg lower end in the curved form.

FIG. 6 is a concave view illustrating how a single, partially compacted leg has the leg lower end in the transition form.

FIG. 7 is a concave view illustrating how a single, most compacted leg has the leg lower end in the coiled form.

FIG. 8 is a concave view illustrating how a single, partially compacted leg (e.g. FIG. 6) is made compact by wrapping around the support stage.

FIG. 9 is a side view of the support device with extended legs where the leg lower ends are in the curved form.

FIG. 10 is a side view of the support device in a most compacted state where the leg lower ends are in the coiled form.

FIG. 11 is a side view of the support device where the legs ends are made proximate to the curved form by wrapping around the support stage.

FIG. 12 is a side view of the tripod in FIG. 9 with the addition of a leg interbrace.

FIG. 13 is a side view of the tripod in FIG. 9 with the addition of an adaptable leg guide.

FIG. 14 is a view of the adaptable leg guide showing slots for three legs.

FIG. 15 is convex view showing three legs pinned to the mandrel at a pivot point.

FIG. 16 is concave view showing three legs pinned to the mandrel with winding cuts made into the leg.

FIG. 17 is cross-sectional view of a tube with mathematical variables marked.

### DETAIL DESCRIPTION

It will be apparent to those skilled in the art that various additions, substitutions and modifications can be made to the described embodiments without departing from the spirit and scope of the invention as defined in the claims and following description. Additionally, the elements and functions of the appended claims should be considered inclusive.

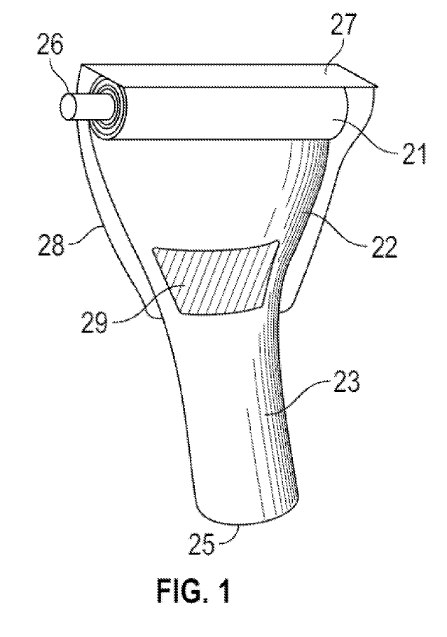

FIG. 1 presents the Zerk leg in U.S. Pat. No. 1,962,547. The leg presented is just one of the three used in that patent's tripod, and not all of the Zerk elements are illustrated. The relevant elements of the Zerk leg are the coil portion 21 of the leg that is present when Zerk leg is wound into its compact state or when the leg is not fully extended. Below coil 21 is transition form 22 followed by curved form 23. The lower end of the leg is designated 25 which may be terminated with a footing piece (not shown). For winding up the leg there is mandrel 26. There is an outer housing 27 termed the “magazine” by Zerk, and it supports the mandrel and houses the compacted leg. Magazine 27 also consists of a lower portion termed the “magazine extension warped surface portion” 28 and “presser plate” 29. The purpose of 28 and 29 is to rigidly keep transition form 22 in its shape. U.S. Pat. No. '547 teaches that portion 28 is required to support the transition zone since “it is important to have means to reinforce the strip throughout the length of that portion thereof which is flat or in only partially curved formation.”

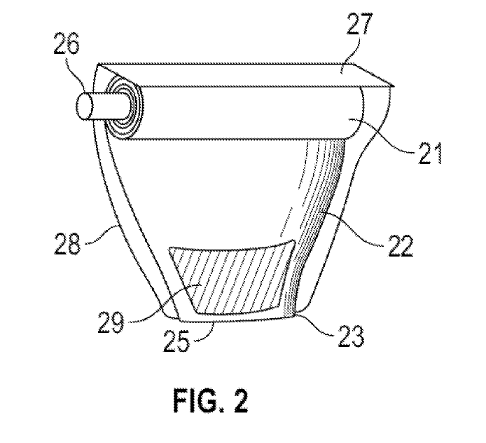

Zerk states that the goal of his invention is “to make a tripod which can be collapsed to occupy a minimum amount of space”. To do so, Zerk states “I make this extension as short as possible.” Zerk contemplates shortening the length of 28 but dismisses the idea and only chooses to “make the extension sufficiently long and of such shape that the strip of steel will assume its normal shape while it is still reinforced and supported by the extension.” Thus, 28 must be extend well below coil 21. FIG. 2 represents the most compact form of the Zerk tripod leg where the entire transition form 22 is still present, and the leg lower end 25 still exists in the curved form 23. Zerk is so confident that the entire transition form must be present, even while the leg is in its most compact state, that the leg has a footing “secured to the curved lower end . . . preferably attached by welding”.

The '547 patent also teaches that the leg curved form 23 is limited in it shape. Zerk proved out the invention and apparently experimented with different leg cross-sections. U.S. Pat. No. '547 provides dimensions for two sets of successfully strong legs. In both cases the legs are channel-shaped (aka U-shaped) possessing a subtending angle of approximately 180°. The calculated subtending angles for the '547 legs varies somewhat according to the formula used (whether based on the leg height or width). But for the two legs presented, the larger leg has a subtending angle of 174-208° and the smaller leg has a subtending angle of 171-196°.

The leg elements are described in terms of a “subtending angle”. The subtending angle is the angle measured at the centerpoint of a partial or complete circle, that is formed when lines are drawn from the centerpoint to the ends of an arc. For this definition, the arc is the cross-section of leg material that is present in the curved form of the leg. For example, a leg with a cross-section that is a quarter circle, has a subtending angle of 90°. Extending that example, as the cross-section of the leg material increases, the subtending angle increases (half circle=180°, full circle=360°, and one & a half circle=540°). Note that for the purposes herein, the subtending angle may also be generally applied to leg shapes that are not circular (as are the legs in '547). The subtending angle can be applied to leg cross-sections that are oval, polygon, and the other shapes.

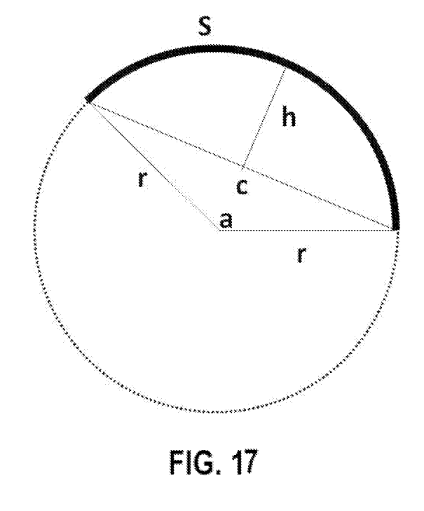

The different measurements that can be used to calculate the subtending angle are represented in the FIG. 17. Since some of the calculations require finding the root of an equation, the calculations have been conveniently automated in a spreadsheet available at (http://mathforum.org/dr.math/gifs/ChordMath.xls). “S” is the arc length, which is the cross-section of the curved form of the leg. The arc length is also the width of the coil form of the leg. The radius of the complete or partial circle is “r”. The height and width of the leg's curved form are “h” and “c”, respectively. The subtending angle is marked as “a”.

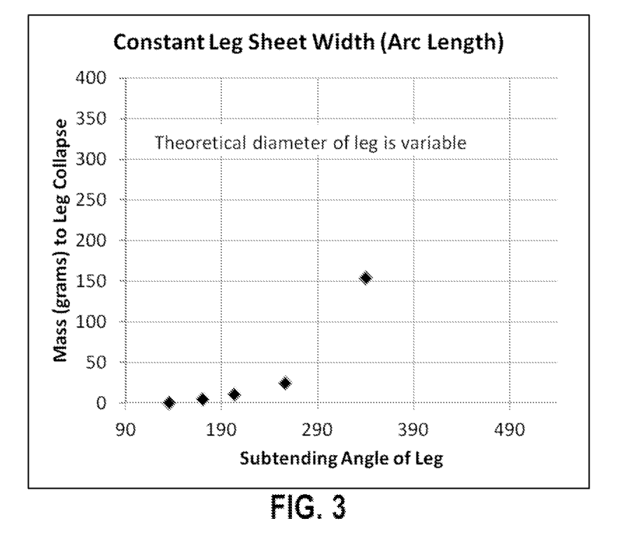

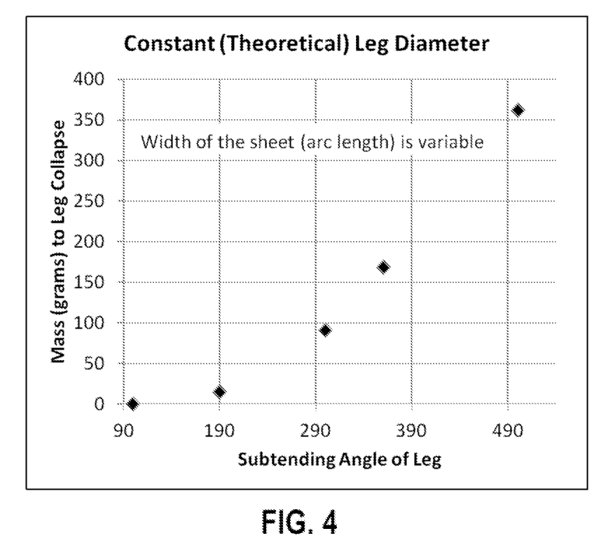

FIGS. 3 and 4 present data from a set of experiments to determine reasonable leg subtending angles for the support device. In contrast to the teachings of '547, a leg with a channel cross-section with a subtending angle of ˜180° was determined to be very weak. A prototype tripod made with polycarbonate legs, each with a subtending angle of 180° (mimicking the legs in '547). This tripod could only stand a few inches tall. When the legs were extended beyond several inches the 180° legs buckled, causing the tripod to collapse.

FIG. 3 illustrates data taken from a polycarbonate sheet 38 microns thick, and 5.1 cm wide, and 120 cm long, thus the arc length “S” is fixed at 5.1 cm. The sheet was thermoformed in progressively smaller tubes to create a leg with an ever increasing subtending angle. At each cross-section shape formed, the leg was tested for support strength. For FIG. 3, one end of the leg was supported on the edge of a benchtop such that 89 cm of the leg was unsupported. Beginning with a first leg subtending angle of 135°, this 89 cm length was found to be the maximum length where the leg was self-supporting of its own weight. This 135° point is plotted with the supported mass=0. As the leg was progressively thermoformed to have a greater subtending angle, at each step the leg was reset on the benchtop with 89 cm suspended. Increasing weight was added to the unsupported end of the leg until it buckled and collapsed. If a line is drawn though the five data points, the slope of the line is 1 at ˜275°. Once the slope of the curve equals 1, for every degree the subtending angle increases, the weight the leg will support increases even more rapidly. Therefore, for this leg composition, a subtending angle of ˜275° represents the starting point to produce a strong leg for a minimum amount of material.

FIG. 4 illustrates data taken from a collection of polycarbonate sheets cut from the same stock of 30 mm diameter slit tube (38 micron wall thickness, 120 cm length). The sheets were cut such that while the radius “r” of the cross-section circle (or partial circle) stayed fixed at 15 mm, the arc length “S” increased. For each cross-section shape cut, the leg was tested for support strength. For FIG. 4, one end of the leg was supported on the edge of a benchtop such that 83 cm of the leg was unsupported. Beginning with a first leg subtending angle of 99°, this 83 cm length was found the maximum length where the leg was self-supporting of its own weight (supported mass=0). As new legs were cut to have a greater subtending angle, the leg was reset on the benchtop with 83 cm suspended. Increasing weight was added to the unsupported end of the leg until it buckled and collapsed. If a line is drawn though the five data points, the slope of the line is 1 at ˜310°. Therefore, for this leg composition, a subtending angle of ˜310° represents the starting point to produce a strong leg for a minimum amount of material.

From the experiments above, the preferred subtending angle of the curved form of the leg, is minimally 225°. Below 225° the leg may be functional, but not robust enough to create a support device that will find market acceptability. The maximum subtending angle is preferred to be 630°, at which point the curved form of the leg consists of 1.75 circles (in cross-section). In practice, the most preferred subtending angle is between 360° and 450° since that is the subtending angle that commonly formed when a variety of extruded plastic tubes were slit lengthwise. This method of slitting the tube is the preferred method of making the leg from a low-cost manufacturability perspective.

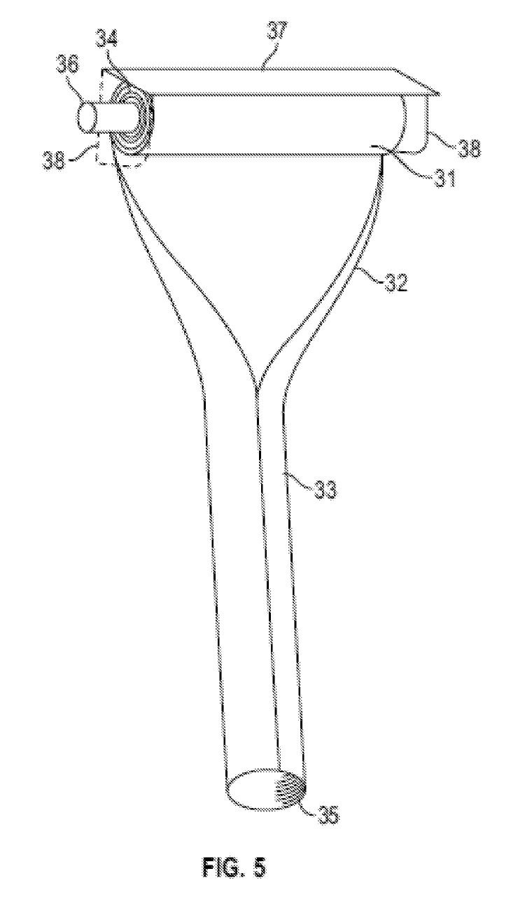

In order to illustrate the subject of this invention, representations of a single leg and mandrel are provided in FIGS. 5 to 8. These figures more easily represent the different transitions of the legs. A single, partially extended leg is presented in FIG. 5. The elements of the invention are the portion of the leg still in the coil form 31, the transition form 32, the curved form of the leg 33, and the leg lower end 35. The leg upper end 34 is where the leg connects to mandrel 36 and is difficult to see. Stage 37 is the upper surface in the figure and the item to be supported is resting or attached to 37, but the item is not presented in this or other figures. There are two arms 38 which are components of stage 37 and are present to hold mandrel 36 to stage 37. Note that nearer arm 38 is presented as transparent in the drawing so that coil form 31 can be more easily visualized.

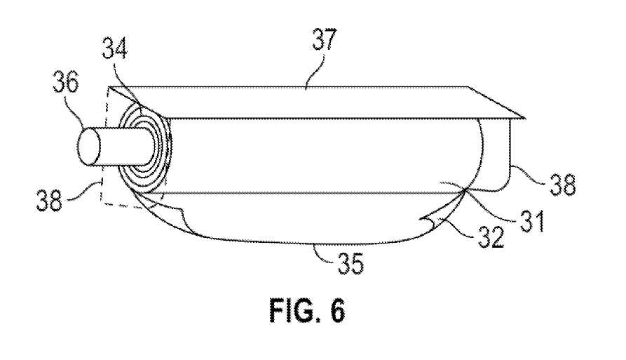

FIGS. 6, 7, and 8 are different representations of compact states of this single leg. In FIG. 6, the extended leg from FIG. 5 has been further coiled around mandrel 36, shortening the leg so that the leg lower end 35 is no longer in the curved form. Rather, 35 is now part of transition form 32, and there is no curved form 33. Even though 35 is still in transition form 32, it is now proximate to the coiled form 31, and the overall leg is more compact than in art such as the '547 patent, where there are elements present that restrict the leg from becoming more compact. For some support device designs it is preferred that the compact leg has transition form 32 present to some degree because it provides a surface for a user to grab and pull in order to extend the leg.

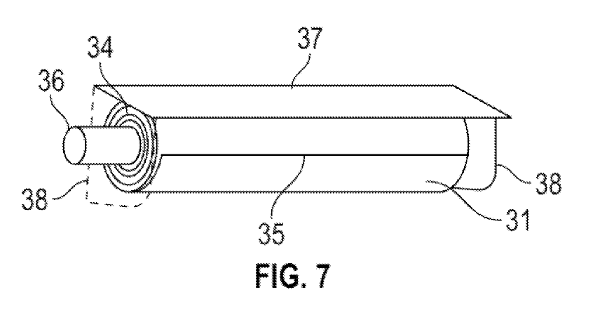

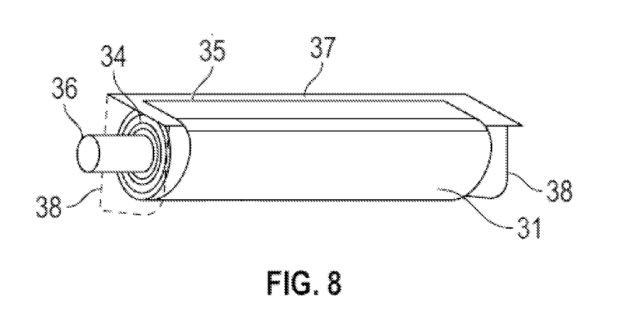

The most compact form of the single leg is presented in FIG. 7. In this preferred form, from a compactness standpoint, the leg lower end 35 is approximately flat to the coil form 31. Another degree of compactness is illustrated in FIG. 8 with the leg lower end 35 proximate to the coil form by wrapping the lower end of the leg around the device itself. This method of making the leg compact is preferred for some designs since it allows the user to easily unwrap and pull to extend the leg.

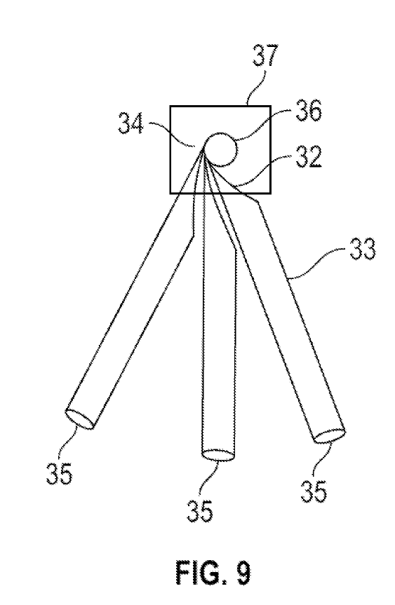

The subject of this invention is presented in FIG. 9 and subsequent figures. An extended tripod is shown in FIG. 9. The elements of the invention are the portion of the legs still in the transition form 32, the curved form of the leg 33, and the leg lower end 35. The leg upper end 34 is where the legs connect to mandrel 36 and is difficult to see. Stage 37 is the upper surface in the figure and the item to be supported is resting or attached to 37. The legs are spread into 3 dimensions and placed on the floor in order for the support device to be free-standing.

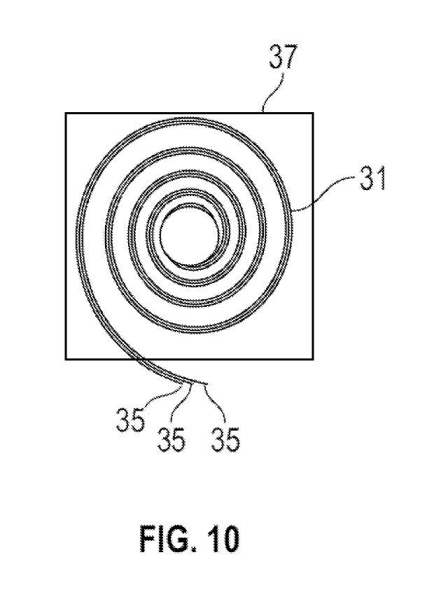

A compact form of the support device is presented in FIG. 10. In this preferred form, from a compactness standpoint, leg lower ends 35 are approximately flat to the coil forms 31. The legs are intercoiled since they are wound up simultaneously. There is no curved form 33 present for any of the legs as shown.

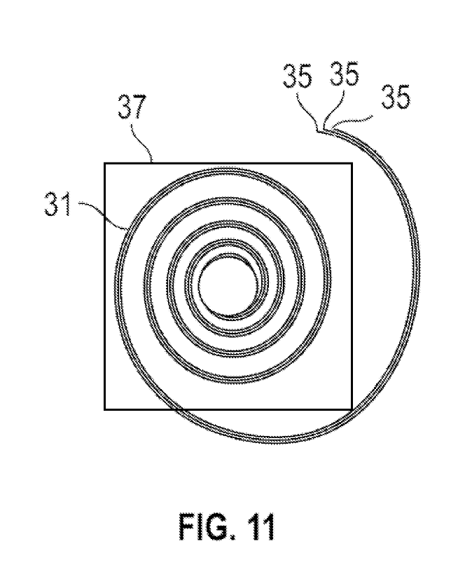

FIG. 11 is similar to FIG. 10, except that the legs are not fully wound into the coil form 31. Rather, the support device is made compact by bringing the leg ends 35 into proximity to coil form 31 by wrapping the lower portion of the legs around the support device itself. In FIG. 11, the leg ends 35 are shown to be ending on the top of stage 37, but the leg ends 35 can end at any point around the circumference of the device.

Note that in the figures the leg is illustrated as possessing approximately a 360° subtending angle. This representation should not be interpreted to limit the claimed subtending angles of curved form 33. Regarding the subtending angle, one of the primary advantages of this invention is that the compact height of the leg is independent of the subtending angle and/or effective diameter of the leg. A third set of experiments was performed which demonstrates that the strength of the leg can be increased without increasing the height of coil form 31.

In this third set of experiments, data confirms the trends in FIGS. 3 and 4 that a larger leg makes for a stronger leg. Two legs were created from extruded tubing of differing diameters that were polycarbonate with a wall thickness of ˜38 microns. The data is presented in Table 1 with one major conclusion: with this invention, the legs can be made larger and stronger without increasing the compact height of the leg (i.e. there is no compact-size height penalty for having the longer transition form due to a larger, stronger leg).

For the experiment in Table 1, the two tubes (116 cm long) were slit longitudinally to create two slit tube legs (e.g., the curved form of the leg). Due to residual stresses in the tubes, both legs possessed a subtending angle >360° (e.g., the longitudinal edges of the leg overlapped, and the legs each possessed a smaller diameter than their original tubes). The tubes were secured between benchtops with a 93 cm spacing, and a bucket was suspended from the centerpoint of the suspended tube form. With the “slit” (i.e. overlapping edges) facing upward, water was slowly added to the bucket until the leg buckled. The mass of the bucket and water for each leg was recorded. The legs were then coiled around a mandrel with a 1.8 cm diameter.

Regarding the row “Length of transition form”, in practice it is difficult to determine the length of the transition form since the boundary between the bottom of the transition form and the top of the curved form be chosen at different points. For this experiment, the length of the transition form was determined by coiling the leg around the mandrel until the diameter of leg lower end 35 began to surpass what the diameter of 35 was when it was obviously in the curved form (e.g., the leg lower end began to widen into the transition form). The length of the transition form was then measured from near the top the coil form, which is where the flattened material began to curve on the edges. Note that for the prior art, the measured height of the transition form is equal to the height of their most compact leg form (since the entire length of the transition form must be supported by a rigid form).

Contrasting with the prior art, since the leg of this invention has a compact size that is not limited by the length of the transition form, the leg of this invention can achieve a much more compact state. To show this, after the transition length was measured, each leg was further wound around the mandrel until the both the coil form and transition form were absent, and the leg lower end was in the coil form. At this point the height of the compact leg is equal to the height of the coil. Note that both the stronger and weaker leg possess the same compact height (i.e. there is no compact height penalty for use a larger, stronger leg).

TABLE 1
Compact Leg Height of Invention is Independent of Leg Strength.

| | Large Leg | | Small Leg | |
|---|---|---|---|---|
| Length of leg | 116 | cm | 116 | cm |
| Circumference of un-slit tube | 13.1 | cm | 7.4 | cm |
| Diameter of un-slit tube | 4.2 | cm | 2.4 | cm |
| Diameter of leg curved form (slit tube) | 2.8 | cm | 2.0 | cm |
| Arc length “S” of leg curved form | 13.1 | cm | 7.4 | cm |
| Width of leg coil form | 13.1 | cm | 7.4 | cm |
| Mass supported at leg center | 2,386 | g | 861 | g |
| Diameter of mandrel | 1.8 | cm | 1.8 | cm |
| Length of transition form | 26.1 | cm | 15.7 | cm |
| Height of prior art most-compact leg | 26.1 | cm | 15.7 | cm |
| Diameter of coil form | 3.2 | cm | 3.2 | cm |
| Height of this invention most-compact leg | 3.2 | cm | 3.2 | cm |

In FIG. 5 and all subsequent figures, note that there is a no support structure that extends the length of transition form 32 (e.g., extending from the coil 31 downward). This absence is in stark contrast to the leg presented in FIGS. 1 and 2 where that support structure is required. Also note that since there is no support structure, leg lower end 35 can be drawn closer to coil 31 (i.e. becoming more compact) and change from curved form 33 into transition form 31 or coiled form 31.

Leg lower end 35 is optionally enhanced by the use of a footing. The purpose of the footing is to limit unwanted movement of the support device by sliding on a slippery floor. The footing may take many different forms but it is limited in that it must allow leg lower end 35 to change from the curved form. That is, if the footing was a solid, non-removeable rubber fitting, then leg lower end 35 is locked into place in the curved formed. And if 35 is locked into the curved form, it cannot achieve the more compact state that is the benefit of this invention. Several different forms of footing have been investigated and each presents their own benefits. A rubberized footing may be created at leg lower end 33 by dipping 33 into a material such as Plasti-Dip. Alternatively, 33 can be covered with a foam tape. In these two examples the footing is flexible and changes shape with leg lower end 33 as it transitions from curved form 33 to forms 32 and 31. In contrast, the footing may be more rigid but removable, detachable, or simply swings aside. In this case, which is less preferred from our manufacturing standpoint, the footing could be a conventional rubber foot that is produced as a footing for tripods, chairs, canes, and the like.

The material that is used to manufacture the leg may possess different material properties. The leg, similar to the Zerk leg, may be manufactured using thin steel, but this is not preferred from a weight stand point. Plastic-based legs are therefore preferred for this invention. A number of experiments were performed in order to identify suitable materials for the leg. The tested criteria were: commercial availability, strength when extended to 4 feet in length in the curve form, ability to wind into the coil form, ability to reversibly transform between the curve and coil forms, and ability to reversibly transform between the coil and curve forms after storage at elevated temperature. Plastic materials that were successfully tested include polyethylene terephthalate, polyethylene terephthalate glycol, and polycarbonate. Most preferred is polycarbonate since it can be acquired readily in a thin-wall tube that can be slit, and it is unaffected by storage at 140° C.

While polycarbonate is preferred, it is envisioned that numerous other materials can be manufactured that would meet the requirements of this invention. Plastic tempering, plasticizers, monomer additives, extrusion stresses, and similar variables all impact the properties a polymer can possess. Since polymers are less dense than metals, that density property also makes them preferred over metal legs. Also, combinations of different materials prove suitable for some applications such as a light, narrow strip of spring steel bound to a wider strip of polylactic acid. Preferred for cost savings is a single material such as a plastic.

In general, the longer the leg the stronger it should be. Tests with legs that are manufactured by slitting an 8 foot long, 3 inch diameter polycarbonate tube have proven sufficiently strong when used to create a tripod. Tripods of this height may be preferred for elevating lights above a work station.

A leg modification that is envisioned for the invention is a series of interlocks that extend down the length of one or both longitudinal edges of the leg. The interlocks act to connect the two longitudinal edges together further strengthening the extended curved tube form. Numerous means of interlocking edges that come-together are available in the literature.

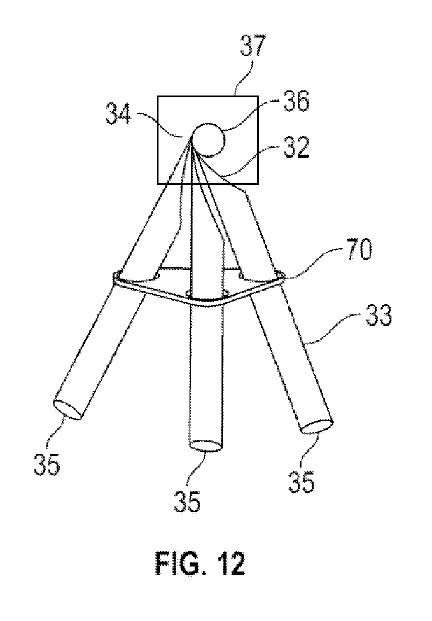

Prototypes of the support device have proven to be successful at being a support device for a small camera, but it may be further improved by optional interbrace 70. As shown in FIG. 12, interbrace 70 interconnects and supports the legs at a point below the main support device body. Interbrace 70 is preferred if the support device is to be transported and re-set under rough conditions without the user needing to readjust the position of leg lower end 35. Interbrace 70 is not preferred from the standpoint that it may require an additional user step during set-up and take-down of the support device.

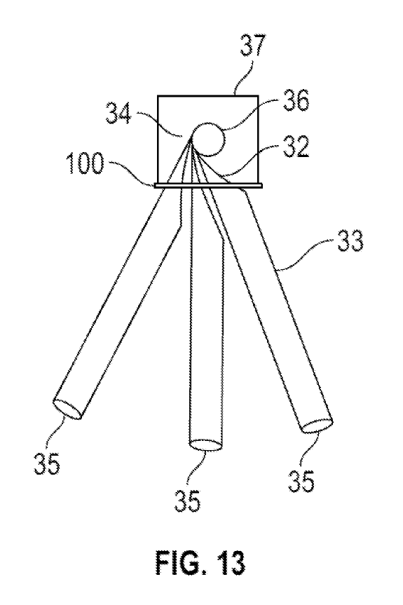

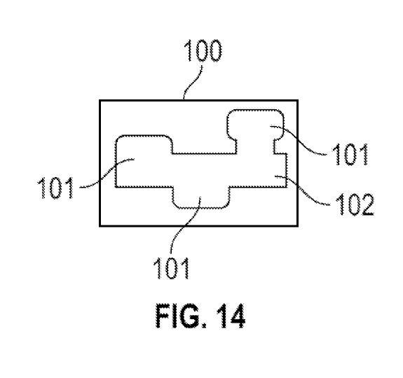

Another element to provide additional support the legs is to use an adaptable guide as shown in FIG. 13. The guide is proximate to the coils forms of the leg and as such, must be able to support the legs when extended, yet allow the legs to flatten into the coil form. FIG. 14 shows one example of how guide 100 may accomplish this task. Guide 100 has 3 slots 101 which are used to hold the legs in place when the support device is in use to support an item. As the legs are wound into the coil form, they need to flatten out. Slot 102 in guide 100 provides space for curved and partially-curved legs to move through their transition forms until the leg lower end reaches guide 100 and 102 accommodates the now-flattened leg lower ends. An advantage of guide 100 is that it does not have to be added or removed by the user. Many other designs can exist for the shape and components of guide 100.

While additional elements to support the legs are provided in FIGS. 12 and 13, in some designs those additional elements are not required, or may be greatly simplified. It is preferred from a raw materials cost standpoint that the legs support each other by being compressed together in a single channel at the bottom of the support device. In this case 100 is a single open cavity. Most preferred from an ease-of-user-operability standpoint for a tripod is when 100 is comprised of three slots that each pinch the transition form 32 of a leg, but then allow the leg to widen into the flat, coiled form 31.

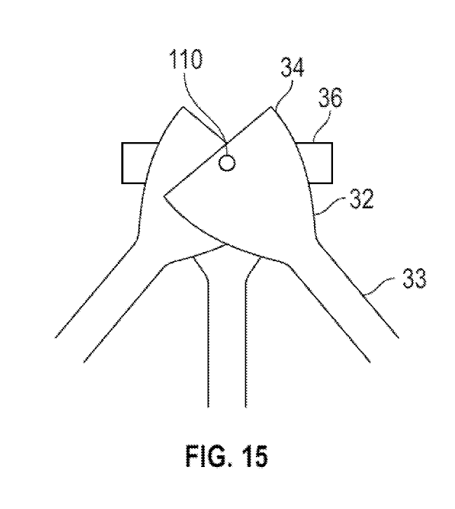

FIG. 15 shows one means for spreading the three legs on a single mandrel in 3 dimensions. While it is possible to deform the transition forms of the legs to make the leg angle in an unnatural direction, a preferred means to angle the leg uses pin 110 to hold the legs to mandrel 36. The pin acts as a pivot point for the legs to move as the support device design requires. For example, in FIG. 15, the far-most leg stays vertical and extends slightly away from the viewer, while the other two legs pivot, one to each side. With that arrangement, the lower ends 35 of the legs makes a stable triangular shape on the floor.

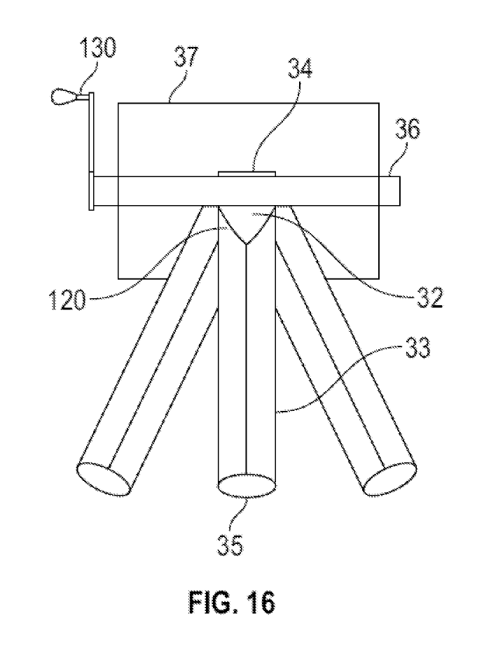

Another adaptation of the legs is shown in FIG. 16. Since the transition form 32 can be very wide, it may be advantageous to trim down one or both sides of the top end 34 of a leg to make trim edges 120. By doing so, the leg more quickly takes on tube form 33. As shown in FIG. 16 as the leg is wound, the trim edges 120 fold open from the action of the winding process. The angle of the trim is in-part variable on the diameter of the mandrel 36, the size of the leg, the material used to make the leg, and the wall thickness of the leg. Take for example a system where tube is polycarbonate, the diameter of the mandrel is held constant at 16 mm, and the width of the uncut flattened tube (i.e. the top end) is 76 mm. Leaving just 10 mm of untrimmed top edge, both edges of the leg's top end are trimmed starting at 33 mm from each end. The two cuts are angled such that they end 50 mm down from the top edge. If this cut is made on a polycarbonate slit tube with a wall thickness of 0.51 mm, the leg can be successfully wound around the mandrel; that is, the two angled edges of the leg spread the leg open as it is wound on the mandrel. However, if the wall thickness of the leg is 0.38 mm, the resiliency of the legs is such that they do not spread as the leg is wound. Rather, both edges of the leg fold during the wind process and the leg is damaged. For this thinner wall, experimentation has found that suitable cuts begin 24 mm from each side (leaving a 28 mm wide top edge), and end 60 mm from the top end of the leg.

Also shown in FIG. 16 is optional winding handle 130. Handle 130 can be a handle as shown, or it may consist of a winding knob. Also, handle 130 may be rigidly affixed to mandrel 36, or more preferred it may be removable or collapsible.

I claim:

1. A support device comprising:
a stage for a supportable item;
a plurality of legs, the leg with an upper and a lower end, the leg transformable between the forms of:
a flattened coil form around a transverse axis,
a transition form, and
an extended curved form around a longitudinal axis; and
a mandrel attachable proximate to the leg upper ends, that is in connection to the stage, and is rotatable around the transverse axis;

2. A support device of claim 1 wherein the legs are extendable to a support state such that the legs are comprised of the curved form, and the legs are coilable to a compact state such that the leg lower ends are proximate to the coil form and the curved form is absent from the legs.

3. A support device of claim 1 wherein the number of legs is three.

4. A support device of claim 1 wherein the legs are coilable around the mandrel to a compact state such that the leg lower ends are proximate to the coil form and the curved form is absent from the legs.

5. A support device of claim 1 wherein the subtending angle of the curved form is between 225 and 630 degrees.

6. A support device of claim 1 further comprising a footing at the leg lower end that is detachable, adjustable, flexible, or a combination thereof such that the leg lower end is transformable into the coil form, transition form, or a combination thereof.

7. A support device of claim 1 wherein the leg is principally comprised of a plastic material, a plastic composite material, or a laminate material.

8. A support device of claim 1 wherein the leg is principally comprised of polycarbonate, polyethylene terephthalate, or polyethylene terephthalate glycol.

9. A support device of claim 1 further comprising a winding handle for the mandrel.

10. A support device of claim 1 wherein the leg has an extended length from 2 feet to 12 feet.

11. A support device of claim 1 wherein the leg is comprised of a material that is monostable in the curved form or is bistable as the curved and coil forms.

12. A support device of claim 1 further comprising an elastic system, a clip system, or a screw attachment system for securing a supportable item to the stage.

13. A support device of claim 1 further comprising a leg guide that retrains the legs when they are in a support state, and allows the legs to transform to the flattened coil form.

14. A support device of claim 1 wherein the leg is pinned to the mandrel with a pin such that the leg can pivot at the pin.

15. A tripod comprising:
a stage for a supportable item;
three legs, the leg transformable between the forms of a flattened coil form around a transverse axis and an extended curved form around a longitudinal axis; and
a mandrel attachable proximate to the leg upper ends, wherein the mandrel is in connection to the stage, and is rotatable around the transverse axis of the legs.
